(19) United States
(12) Patent Application Publication
(10) Pub. No.: US 2007/0098464 A1
(43) Pub. Date: May 3, 2007

(54) Image transfer unit, electrophotographic image forming apparatus including the same, and electrophotographic image forming method

(75) Inventors: Byung-hwa Ahn, Seongnam-si (KR); Heung-sup Jeong, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/496,448

(22) Filed: Aug. 1, 2006

(30) Foreign Application Priority Data
Nov. 3, 2005 (KR) 2005-0104931

(51) Int. Cl. G03G 15/01

(52) U.S. Cl. 399/303

(57) ABSTRACT

An image transfer unit includes at least one photosensitive medium on which an electrostatic latent image is formed by light scanning and a toner image formed by transferring toners onto the electrostatic latent image. A transfer belt is wound on at least a pair of rollers and circulates around the rollers and forms a transfer nip by contacting the photosensitive medium. A linear velocity of the transfer belt is set to be faster than linear velocity of an outer circumferential surface of the photosensitive medium contacting the transfer belt.

### CROSS-REFERENCE TO RELATED PATENT APPLICATIONS

This application claims the benefit under 35 U.S.C. § 119(a) of Korean Patent Application No. 10-2005-0104931, filed on Nov. 3, 2005, in the Korean Intellectual Property Office, the entire disclosure of which is hereby incorporated by reference.

### BACKGROUND OF THE INVENTION

1. Field of the Invention

The present invention relates to an electrophotographic image forming apparatus. More particularly, the present invention relates to an image transfer unit substantially preventing defective color registration, an electrophotographic image forming apparatus including the image transfer unit, and an electrophotographic image forming method.

2. Description of the Related Art

Generally, an electrophotographic image forming apparatus, such as a laser printers or digital copying machine, forms an electrostatic latent image on an outer surface of a photosensitive medium by scanning light onto the photosensitive medium that is charged to a predetermined electric potential. The electrostatic latent image is developed into a visible image by using a developing agent, such as toner. The visible image is transferred and fused onto a printing medium.

FIG. 1 is an elevational view in cross section of an image transfer unit in an electrophotographic image forming apparatus according to the conventional art.

Referring to FIG. 1, the image transfer unit 10 includes a first roller 11 and a second roller 12 arranged in parallel to each other on upper and lower portions of the image transfer unit 10, and a transfer belt 15 circulating around the first and second rollers 11 and 12. Transfer rollers 20Y, 20M, 20C, and 20K are disposed between the first roller 11 and the second roller 12. Photosensitive media 27Y, 27M, 27C, and 27K, which are included in developers 25Y, 25M, 25C, and 25K, face the transfer rollers 20Y, 20M, 20C, and 20K with the transfer belt 15 being disposed therebetween. The four developers 25Y, 25M, 25C, and 25K respectively store yellow (Y), magenta (M), cyan (C), and black (K) toners for printing a color image. Each of the developers 25Y, 25M, 25C, and 25K includes one of four photosensitive media 27Y, 27M, 27C, and 27K, on which four color toner images are formed, respectively. Additionally, four transfer nips N1, N2, N3, and N4 are formed by the four photosensitive media 27Y, 27M, 27C, and 27K contacting the transfer belt 15. A printing medium drawing roller 30 is disposed on an opposite side of the second roller 12, with the transfer belt 15 being disposed therebetween. When a predetermined voltage is applied to the printing medium drawing roller 30, static electricity is induced to a printing medium P, and thus, the printing medium P is drawn to the transfer belt 15 and is conveyed upwardly.

During the image transfer process of the image transfer unit 10, linear velocities of the outer circumferences of the four photosensitive media 27Y, 27M, 27C, and 27K are the same as a linear velocity of the transfer belt 15. However, even if the linear velocities are designed to be the same, the linear velocities of the outer circumferences of the photosensitive media 27Y, 27M, 27C, and 27K and the linear velocity of the transfer belt 15 may be a bit different from each other due to a tolerance of the first roller 11 driving the transfer belt 15 or a tolerance of a unit supplying driving power to the photosensitive media 27Y, 27M, 27C, and 27K or to the first roller 11.

The difference between the linear velocities may cause a color registration defect of the toner image that is transferred to the transfer belt 15, thereby degrading the printing quality. For example, if it is assumed that the linear velocities of the yellow photosensitive medium 27Y, on which the Y toner image is formed, and the cyan photosensitive medium 27C, on which the C toner image is formed, are slower than the linear velocity of the transfer belt 15, and the linear velocities of the magenta photosensitive medium 27M, on which the M toner image is formed, and the black photosensitive medium 27K, on which the K toner image is formed, are faster than the linear velocity of the transfer belt 15, a part of the printing medium P and the transfer belt 15 around the first and third transfer nips N1 and N3 are pressed downwardly by the yellow and cyan photosensitive media 27Y and 27C, and a part of the printing medium P and the transfer belt 15 around the second and fourth transfer nips N2 and N4 are pressed upwardly by the magenta and black photosensitive media 27M and 27K. Therefore, sections of the printing medium P and the transfer belt 15 between the first transfer nip N1 and the second transfer nip N2 and the sections between the third transfer nip N3 and the fourth transfer nip N4 are tightened. Therefore, the printing medium P and the transfer belt 15 may slip at some of the four transfer nips N1, N2, N3, and N4, and thus, color registration defects may occur.

Accordingly, a need exists for an improved image transfer unit that substantially eliminates defective color registration.

### SUMMARY OF THE INVENTION

The present invention provides an image transfer unit having an improved structure that reduces color registration defects, and an electrophotographic image forming apparatus including the image transfer unit.

The present invention also provides an electrophotographic image forming method substantially preventing the occurrence of color registration defects.

According to an aspect of the present invention, an image transfer unit includes at least one photosensitive medium on which an electrostatic latent image is formed by light scanning and a toner image formed by transferring toners onto the electrostatic latent image. A transfer belt is wound on at least a pair of rollers and circulates around the rollers and forms a transfer nip by contacting the photosensitive medium. A linear velocity of the transfer belt is set to be faster than the linear velocity of the outer circumferential surface of the photosensitive medium contacting the transfer belt. An electrophotographic image forming apparatus includes at least one light scanner scanning laser beam corresponding to an image to be printed, and the above image transfer unit.

The transfer belt may convey a printing medium by attaching the printing medium on a surface of the transfer belt. The toner image is transferred to the printing medium from the photosensitive medium.

The apparatus may include a plurality of photosensitive media to form a plurality of toner images of different colors on the plurality of photosensitive media. The transfer belt may contact the plurality of photosensitive media to form a plurality of transfer nips. The linear velocity of the transfer belt may be set to be faster than the linear velocities of the outer circumferential surfaces of all the photosensitive media.

The linear velocity of the transfer belt may be set to be at most 1.004 times faster than the linear velocity of the outer circumferential surface of the fastest photosensitive medium of the plurality of photosensitive media.

The transfer belt may be elastically adhered to the photosensitive medium.

A driving force for rotating the photosensitive medium may be larger than a driving force for circulating the transfer belt.

According to another aspect of the present invention, an electrophotographic image forming method includes forming an electrostatic latent image on an outer circumferential surface of at least one photosensitive medium by scanning a laser beam corresponding to an image to be printed onto the rotating photosensitive medium. A toner image is formed on the outer circumferential surface of the photosensitive medium by transferring toners on the electrostatic latent image. The toner image is transferred toward a transfer belt, which is wound on at least a pair of rollers and circulates around the rollers and forms a transfer nip by contacting the photosensitive medium. A linear velocity of the transfer belt is set to be faster than the linear velocity of an outer circumferential surface of the photosensitive medium contacting the transfer belt.

The transfer belt may convey a printing medium by attaching the printing medium on a surface of the transfer belt. The toner image may be transferred to the printing medium from the photosensitive medium in the transferring of the toner image.

A plurality of photosensitive media may be provided to form a plurality of toner images of different colors on the plurality of photosensitive media in the forming of the toner image. The toner images of different colors may be transferred from the photosensitive media to the transfer belt sequentially in the transferring of the toner image. The linear velocity of the transfer belt may be faster than the linear velocities of the outer circumferential surfaces of all photosensitive media.

The linear velocity of the transfer belt may be at most 1.004 times faster than the linear velocity of the outer circumferential surface of the fastest photosensitive medium of the plurality of photosensitive media.

Other objects, advantages and salient features of the invention will become apparent from the following detailed description, which, taken in conjunction with the annexed drawings, discloses exemplary embodiments of the invention.

### BRIEF DESCRIPTION OF THE DRAWINGS

The above and other features and advantages of the present invention will become more apparent by describing in detail exemplary embodiments thereof with reference to the attached drawings, in which:

FIG. 1 is an elevational view in cross section of an image transfer unit of an electrophotographic image forming apparatus according to the conventional art;

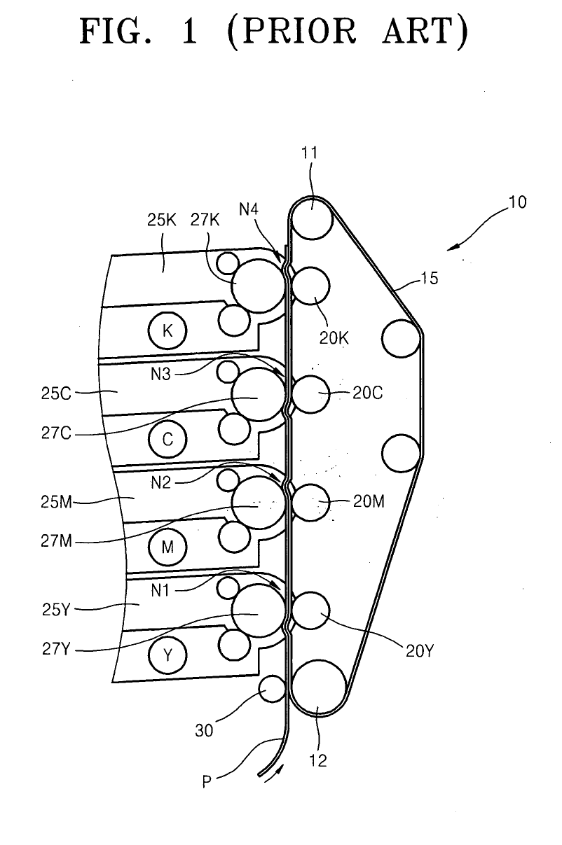

FIG. 2 is an elevational view in cross section of an electrophotographic image forming apparatus according to an exemplary embodiment of the present invention; and

FIG. 3 is an elevational view in cross section of an image transfer unit of the apparatus of FIG. 2.

Throughout the drawings, like reference numerals will be understood to refer to like parts, components and structures.

### DETAILED DESCRIPTION OF EXEMPLARY EMBODIMENTS

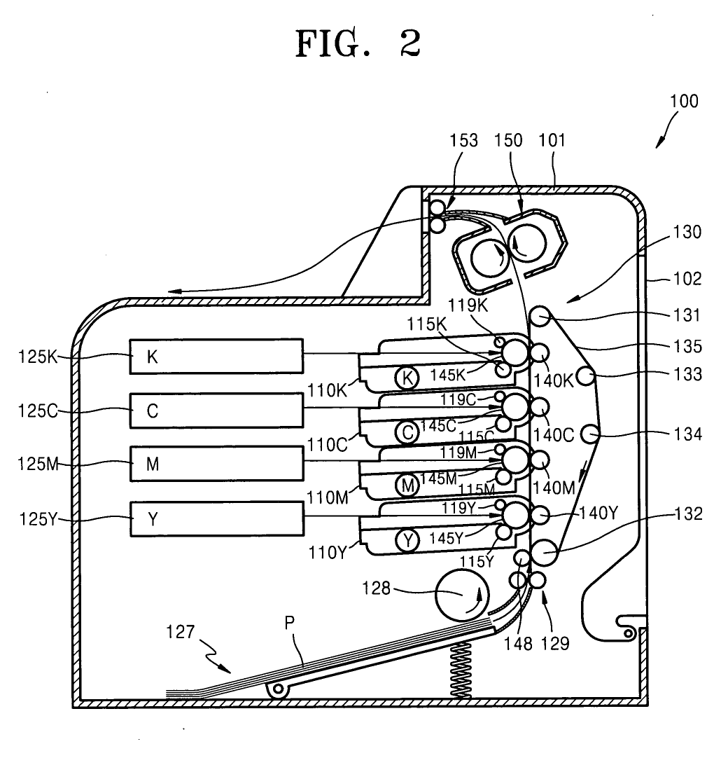

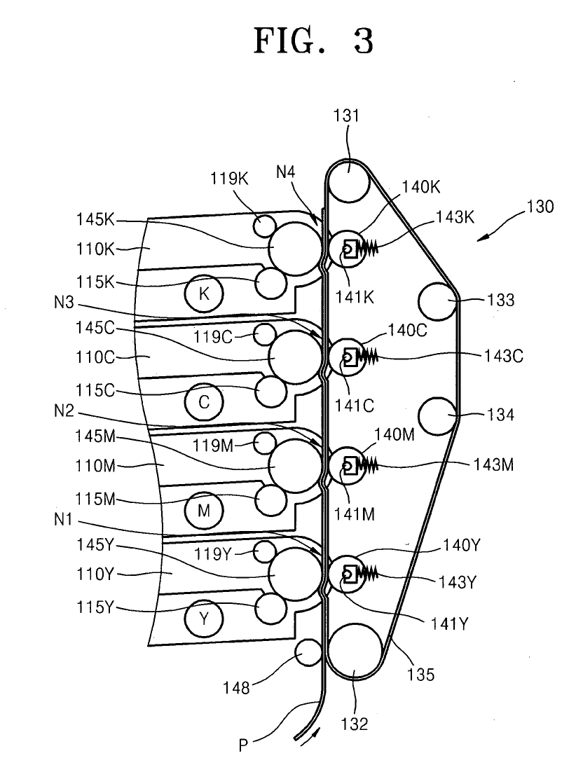

FIG. 2 is an elevational view in cross section of an electrophotographic image forming apparatus according to an exemplary embodiment of the present invention. FIG. 3 is an elevational view in cross section of an image transfer unit in the electrophotographic image forming apparatus of FIG. 2.

Referring to FIG. 2, the electrophotographic image forming apparatus 100 is a direct transfer type color image forming apparatus in which visible toner images of different colors are sequentially transferred onto a printing medium to form a color image directly on the printing medium P. The electrophotographic image forming apparatus 100 includes four developers 110Y, 110M, 110C, and 110K, four light scanners 125Y, 125M, 125C, and 125K, an image transfer unit 130, and a fuser 150, all of which are accommodated in a case 101. Additionally, the image forming apparatus 100 further includes a paper cassette 127 loading printing media P, a pickup roller 128 picking a printing medium P from the paper cassette 127 one by one, a conveying roller 129 conveying the picked printing medium P, and a discharge roller 153 discharging out of the case 101 the printing medium P on which an image is printed.

The developers 110Y, 110M, 110C, and 110K are of a cartridge type, and may be replaced when toner, that is, a developing agent, contained therein is exhausted. In FIG. 2, the four developers include toners of different colors, for example, yellow (Y), cyan (C), magenta (M), and black (K) colors, respectively.

When a door 102 on a side of the case 101 is opened, a transfer belt 135 is disposed in a lateral direction in communication with the opening of the door 102, and thus, the developers 110Y, 110M, 110C, or 110K, the toner of which is exhausted, may be replaced.

According to an exemplary embodiment of the present embodiment, four light scanners 125Y, 125M, 125C, and 125K are formed to correspond to the four developers 110Y, 110M, 110C, and 110K. Each of the light scanners 125Y, 125M, 125C, and 125K scans a laser beam corresponding to image information of Y, M, C, and K to photosensitive media 145Y, 145M, 145C, and 145K installed in the developers 110Y, 110M, 110C, and 110K, respectively. Alternatively, laser scanning units (LSUs) using a laser diode as a light source may be used as the light scanner 125Y, 125M, 125C, and 125K.

The developers 110Y, 110M, 110C, and 110K respectively include the photosensitive media 145Y, 145M, 145C, and 145K and developing rollers 115Y, 115M, 115C, and 115K. The outer circumferential surfaces of the photosensitive media 145Y, 145M, 145C, and 145K contact the transfer belt 135 to transfer toner images. Additionally, the developers 110Y, 110M, 110C, and 110K respectively include charging rollers 119Y, 119M, 119C, and 119K. Charging biase voltages are applied to the charging rollers 119Y, 119M, 119C, and 119K to charge the outer circumferential surfaces of the photosensitive media 145Y, 145M, 145C, and 145K to a constant electric potential.

The toners are attached to the outer circumferential surfaces of the developing rollers 115Y, 115M, 115C, and 115K, and then, supplied to the photosensitive media 145Y, 145M, 145C, and 145K. Developing bias voltages are applied to the developing rollers 115Y, 115M, 115C, and 115K to supply toners to the photosensitive media 145Y, 145M, 145C, and 145K. Additionally, although not shown in the drawings, each of the developers 110Y, 110M, 110C, and 110K includes a supplying roller for supplying the toner to the developing roller 115Y, 115M, 115C, or 115K, a doctor blade for controlling an amount of the toner attached on the developing roller 115Y, 115M, 115C, or 115K, and an agitator for agitating the toner respectively received in the developers 110Y, 110M, 110C, or 110K and conveying the toner to the supplying roller.

The image transfer unit 130 includes the four photosensitive media 145Y, 145M, 145C, and 145K. Additionally, the image transfer unit 130 includes a first roller 131, that is, a driving roller, and a second roller 132, that is, a slave roller, disposed under the first roller 131 in parallel to the first roller 131. The transfer belt 135 is wound on the first and second rollers 131 and 132 to circulate thereon. Four transfer rollers 140Y, 140M, 140C, and 140K are disposed between the first roller 131 and the second roller 132. Additionally, the image transfer roller 130 also includes auxiliary supporting rollers 133 and 134 supporting the transfer belt 135. The four transfer rollers 140Y, 140M, 140C, and 140K are disposed on opposite sides of the four photosensitive media 145Y, 145M, 145M, and 145K with the transfer belt 135 being disposed therebetween. A transfer bias voltage is applied to the transfer rollers 140Y, 140M, 140C, and 140K.

A driving force for rotating the photosensitive media 145Y, 145M, 145C, and 145K in the electrophotographic image forming apparatus 100 is larger than a driving force for circulating the transfer belt 135. A driving gear (not shown) supplying the driving force is connected to each of the photosensitive media 145Y, 145M, 145M, and 145K. However, the transfer belt 135 is circulated only by the driving force of the first roller 131. Additionally, the other rollers 132, 133, 134, 141Y, 141M, 141C, and 141K are the slave rollers driven by the circulation of the transfer belt 135, and thus, the driving force of the transfer belt 135 is smaller than the rotational driving force of the photosensitive media 145Y, 145M, 145C, and 145K.

Referring to FIG. 3, shafts 141Y, 141M, 141C, and 141K of the transfer rollers 140Y, 140M, 140C, and 140K are elastically pressed toward the photosensitive media 145Y, 145M, 145C, and 145K by springs 143Y, 143M, 143C, and 143K. The transfer belt 135 is elastically adhered to the photosensitive media 145Y, 145M, 145C, and 145K by the elastic force, and thus, transfer nips N1, N2, N3, and N4 may be stably maintained. Additionally, the image transfer unit 130 includes a printing medium drawing roller 148 disposed on an opposite portion of the second roller 132 with the transfer belt 135 disposed therebetween. The printing medium drawing roller 148 charges the printing medium P that is picked from the paper cassette 127 and moved upwardly by using static electricity so that the printing medium P may be adhered onto the surface of the transfer belt 135.

When the toner images are transferred toward the transfer belt 135 from the photosensitive media 145Y, 145M, 145C, and 145K, the linear velocity of the transfer belt 135 is slightly faster than the linear velocities of the outer circumferential surfaces of the photosensitive media 145Y, 145M, 145C, and 145K in the image transfer unit 130 to substantially prevent color registration defects from being generated. In an exemplary embodiment, the linear velocity of the transfer belt 135 is faster than the linear velocities of the outer circumferential surfaces of the photosensitive media 145Y, 145M, 145C, and 145K. Additionally, the linear velocity of the transfer belt 135 may be set to be approximately 1.004 times faster than the linear velocity of the fastest photosensitive medium among the photosensitive media 145Y, 145M, 145C, and 145K. When the linear velocity of the transfer belt 135 is excessively faster than the linear velocities of the outer circumferential surfaces of the photosensitive media 145Y, 145M, 145C, and 145K, the transfer belt 135 and the printing medium P adhered onto the transfer belt 135 may slip continuously with respect to the photosensitive media 145Y, 145M, 145C, 145K at the transfer nip sections N1, N2, N3, and N4. Therefore, defective printing or jam of the printing medium P may be generated.

Angular velocities of the photosensitive media 145Y, 145M, 145C, and 145K or an angular velocity of the first roller 131, that is, the driving roller, of the transfer belt 135 may be changed to set the linear velocity of the transfer belt 135 to be higher than the linear velocities of the outer circumferential surfaces of the photosensitive media 145Y, 145M, 145C, and 145K. However, this is not easy because the differences between the linear velocities of photosensitive media 145Y, 145M, 145C, and 145K and the linear velocity of the transfer belt 135 are small in the exemplary embodiments of the present invention. Therefore, the angular velocities of the photosensitive media 145Y, 145M, 145C, and 145K and the angular velocity of the first: roller 131 may be set as in the conventional art, and diameters of the photosensitive media 145Y, 145M, 145C, and 145K or a diameter of the first roller 131 may be set to be different from those of the conventional art to set the linear velocity of the transfer belt 135 to be faster than the outer circumferential linear velocities of the photosensitive media 145Y, 145M, 145C, and 145K. Otherwise, the diameters of the photosensitive media 145Y, 145M, 145C, and 145K are substantially the same as in the conventional art and the diameter of the first roller 131 is slightly larger than in the conventional art to set the linear velocity of the transfer belt 135 faster than the outer circumferential linear velocities of the photosensitive media 145Y, 145M, 145C, and 145K. Through the above processes, the image transfer unit 130 of the exemplary embodiments of the present invention may be manufactured easily though it is produced through the manufacturing management system with the same tolerances as in the conventional art.

Hereinafter, printing processes of the electrophotographic image forming apparatus 100 are described with reference to FIGS. 2 and 3.

The photosensitive media 145Y, 145M, 145C, and 145K are charged with a constant electric potential by the charging bias voltages applied to the charging rollers 119Y, 119M, 119C, and 119K. The four light scanners 125Y, 125M, 125C, and 125K scan laser beams corresponding to Y, M, C, and K image information to the photosensitive media 145Y, 145M, 145C, and 145K. Then, Y, M, C, and K electrostatic latent images are formed on the outer circumferential surfaces of the photosensitive media 145Y, 145M, 145C, and 145K. Developing bias voltages are applied to the developing rollers 115Y, 115M, 115C, and 115K. Then, the toners are moved from the developing rollers 115Y, 115M, 115C, and 115K to the outer circumferential surfaces of the photosensitive media 145Y, 145M, 145C, and 145K. Thus, Y, M, C, and K visible toner images are formed on the outer circumferential surfaces of the photosensitive media 145Y, 145M, 145C, and 145K.

The printing medium P is picked by the pickup roller 128 from the paper cassette 127, and is fed by the conveying roller 129. When a predetermined voltage is applied to the printing medium drawing roller 148, the printing medium P fed upwardly is charged by static electricity and adhered onto the surface of the transfer belt 135, and is conveyed at the same velocity as the linear velocity of the transfer belt 135.

A front edge of the printing medium P that is adhered onto the transfer belt 135 to be conveyed reaches the first transfer nip N1 at the time when a front edge of the Y toner image formed on the outer circumferential surface of the lowermost photosensitive medium 145Y reaches the first transfer nip N1 that corresponds to the transfer belt 135. At this time, when the transferring bias is applied to the transfer roller 140Y, the Y toner image formed on the photosensitive medium 145Y is transferred onto the printing medium P. Additionally, as the printing medium P is conveyed, the M, C, and K toner images formed on the other photosensitive media 145M, 145C, and 145K are transferred onto the printing medium P sequentially and overlap each other. Thus, a color toner image is formed on the printing medium P. The fuser 150 applies heat and pressure onto the printing medium P to fuse the color toner image on the printing medium P. The printing medium P on which the toner image is completely fused is discharged out of the case 101 by the discharge roller 153.

As described above, the linear velocity of the transfer belt 135 is slightly faster than the outer circumferential linear velocities of the photosensitive media 145Y, 145M, 145C, and 145K during the printing processes. However, the photosensitive media 145Y, 145M, 145C, and 145K and the transfer belt 135 are adhered to form the transfer nips N1, N2, N3, and N4, and the rotational driving forces of the photosensitive media 145Y, 145M, 145C, and 145K are larger than the driving force of the transfer belt 135. Therefore, the transfer belt 135 and the printing medium P attached on the transfer belt 135 by the static electricity do not slip with respect to the photosensitive media 145Y, 145M, 145C, and 145K at the transfer nips N1, N2, N3, and N4. Instead, the transfer belt 135 and the printing medium P travel at substantially the same velocity as the outer circumferential linear velocities of the photosensitive media 145Y, 145M, 145C, and 145K at the transfer nips N1, N2, N3, and N4, and portions of the transfer belt 135 and the printing medium P under the transfer nips N1, N2, N3, and N4 are pressed downwardly as shown in FIG. 3. Because the transfer belt 135 and the printing medium P are pressed downwardly around the transfer nips N1, N2, N3, and N4, the possibility of slips of the transfer belt 135 and the printing medium P is substantially reduced. Additionally, because the transfer belt 135 and the printing medium P travel at substantially the same velocity as that of the outer circumferential surfaces of the photosensitive media 145Y, 145M, 145C, and 145K at the transfer nips N1, N2, N3, and N4, the color registration defects of the four (YMCK) toner images that are transferred to the printing medium P may be reduced.

According to exemplary embodiments of the present invention, the linear velocity of the transfer belt and the outer circumferential linear velocity of the photosensitive media are substantially the same at the transfer nips. Thus, the printing medium and the transfer belt do not slip at the transfer nips and the color registration defects may be prevented during the transfer of the toner images.

While the present invention has been particularly shown and described with reference to exemplary embodiments thereof, it will be understood by those of ordinary skill in the art that various changes in form and details may be made therein without departing from the spirit and scope of the present invention as defined by the following claims. For example, technical features of the present invention may be applied to an electrophotographic image forming apparatus of intermediate transfer type, that is, a toner image is transferred onto a surface of a transfer belt from a photosensitive medium, and then the toner image is transferred onto a printing medium.

What is claimed is:

1. An image transfer unit, comprising:
at least one photosensitive medium on which an electrostatic latent image is formed by light scanning and a toner image is formed by transferring toners onto the electrostatic latent image; and
a transfer belt wound on at least a pair of rollers and circulating around the rollers and forming a transfer nip by contacting the at least one photosensitive medium,
wherein a linear velocity of the transfer belt is faster than a linear velocity of an outer circumferential surface of the at least one photosensitive medium contacting the transfer belt.

2. The image transfer unit of claim 1, wherein the transfer belt conveys a printing medium by attaching the printing medium on a surface of the transfer belt, and the toner image is transferred to the printing medium from the at least one photosensitive medium.

3. The image transfer unit of claim 1, wherein
a plurality of photosensitive media on which a plurality of toner images of different colors are formed; and
the transfer belt contacts the plurality of photosensitive media to form a plurality of transfer nips, and the linear velocity of the transfer belt is faster than the linear velocities of each of the outer circumferential surfaces of the plurality of photosensitive media.

4. The image transfer unit of claim 3, wherein the linear velocity of the transfer belt is approximately 1.004 times faster than the fastest linear velocity of the outer circumferential surface of the plurality of photosensitive media.

5. The image transfer unit of claim 1, wherein the transfer belt is elastically adhered to the at least one photosensitive medium.

6. The image transfer unit of claim 1, wherein a driving force for rotating the at least one photosensitive medium is larger than a driving force for circulating the transfer belt.

7. An electrophotographic image forming apparatus, comprising:
at least one light scanner scanning laser beam corresponding to an image to be printed; and
an image transfer unit comprising: at least one photosensitive medium on which an electrostatic latent image is formed by light scanning of the light scanner and a toner image is formed by transferring toners onto the electrostatic latent image; and a transfer belt wound on at least a pair of rollers and circulating around the rollers and forming a transfer nip by contacting the at least one photosensitive medium,
wherein a linear velocity of the transfer belt is faster than a linear velocity of an outer circumferential surface of the at least one photosensitive medium contacting the transfer belt.

8. The electrophotographic image forming apparatus of claim 7, wherein the transfer belt conveys a printing medium by attaching the printing medium on a surface of the transfer belt, and the toner image is transferred to the printing medium from the at least one photosensitive medium.

9. The electrophotographic image forming apparatus of claim 7, wherein the image transfer unit includes a plurality of photosensitive media to form a plurality of toner images of different colors on the plurality of photosensitive media, the transfer belt contacts the plurality of photosensitive media to form a plurality of transfer nips, and the linear velocity of the transfer belt is faster than the linear velocities of each of the outer circumferential surfaces of the plurality of photosensitive media.

10. The electrophotographic image forming apparatus of claim 9, wherein the linear velocity of the transfer belt is set to be approximately 1.004 times faster than the linear velocity of the outer circumferential surface of the fastest photosensitive medium of the plurality of photosensitive media.

11. The electrophotographic image forming apparatus of claim 7, wherein the transfer belt is elastically adhered to the at least one photosensitive medium.

12. The electrophotographic image forming apparatus of claim 7, wherein a driving force for rotating the at least one photosensitive medium is larger than a driving force for circulating the transfer belt.

13. An electrophotographic image forming method, comprising the steps of:
forming an electrostatic latent image on an outer circumferential surface of at least one photosensitive medium by scanning laser beam corresponding to an image to be printed onto the rotating photosensitive medium;
forming a toner image on the outer circumferential surface of the photosensitive medium by transferring toners on the electrostatic latent image; and
transferring the toner image toward a transfer belt that is wound on at least a pair of rollers and circulates around the rollers and forms a transfer nip by contacting the at least one photosensitive medium,
wherein a linear velocity of the transfer belt is set to be faster than linear velocity of an outer circumferential surface of the at least one photosensitive medium contacting the transfer belt.

14. The method of claim 13, wherein the transfer belt conveys a printing medium by attaching the printing medium on a surface of the transfer belt, and the toner image is transferred to the printing medium from the at least one photosensitive medium in the transferring of the toner image.

15. The method of claim 13, wherein a plurality of photosensitive media are provided to form a plurality of toner images of different colors on the plurality of photosensitive media in the forming of the toner image, the toner images of different colors are transferred from the plurality of photosensitive media to the transfer belt sequentially in the transferring of the toner image, and the linear velocity of the transfer belt is faster than the linear velocities of outer circumferential surfaces of each of the plurality of photosensitive media.

16. The method of claim 15, wherein the linear velocity of the transfer belt is approximately 1.004 times faster than the fastest linear velocity of the outer circumferential surface of the photosensitive medium of the plurality of photosensitive media.

17. An image transfer unit, comprising:
at least one photosensitive medium on which an image is formed; and
a transfer belt circulating around at least a pair of rollers and forming a transfer nip by contacting the at least one photosensitive medium,
wherein a linear velocity of the transfer belt is faster than a linear velocity of an outer circumferential surface of the at least one photosensitive medium contacting the transfer belt.

18. The image transfer unit of claim 17, wherein the linear velocity of the transfer belt is substantially equivalent to the linear velocity of the outer circumferential surface of the at least one photosensitive medium at the nip.

19. The image transfer unit of claim 17, wherein the transfer belt conveys a printing medium by attaching the printing medium on a surface of the transfer belt, and the toner image is transferred to the printing medium from the at least one photosensitive medium.

20. The image transfer unit of claim 17, wherein
a plurality of photosensitive media on which a plurality of toner images of different colors are formed; and
the transfer belt contacts the plurality of photosensitive media to form a plurality of transfer nips, and the linear velocity of the transfer belt is faster than the linear velocities of each of the outer circumferential surfaces of the plurality of photosensitive media.

21. The image transfer unit of claim 20, wherein the linear velocity of the transfer belt is approximately 1.004 times faster than the fastest linear velocity of the outer circumferential surface of the plurality of photosensitive media.

22. The image transfer unit of claim 20, wherein the linear velocity of the transfer belt is substantially equivalent to the linear velocity of the outer circumferential surface of each of the plurality of photosensitive media at the respective nip formed therebetween.

23. The image transfer unit of claim 17, wherein the transfer belt is elastically adhered to the at least one photosensitive medium.

24. The image transfer unit of claim 17, wherein a driving force for rotating the at least one photosensitive medium is larger than a driving force for circulating the transfer belt.
